(19) United States
(12) Patent Application Publication
(10) Pub. No.: US 2018/0330597 A1
(43) Pub. Date: Nov. 15, 2018

(54) METHOD AND APPARATUS FOR REAL PROPERTY ALARM SYSTEM

(71) Applicant: Katerra, Inc., Menlo Park, CA (US)

(72) Inventors: Sean Burke, Morgan Hill, CA (US); Brian Joseph Reeves, Hamilton (CA); Paul Edward Reeves, Oakville (CA)

(21) Appl. No.: 15/963,031

(22) Filed: Apr. 25, 2018

Related U.S. Application Data
(60) Provisional application No. 62/504,005, filed on May 10, 2017.

(51) Int. Cl. G08B 21/22; G08B 13/22

(52) U.S. Cl. CPC G08B 21/22; G08B 29/185; G08B 13/22

(57) ABSTRACT

An alarm system receives input indicating occupancy state of a designated area, selects a confidence level regarding occupancy state of the designated area responsive to the received input, receives notification of a potential alarm event from one or more of a plurality of sensors of, within, or proximate to, the alarm system and/or the designated area, and selects an action to be taken responsive to the potential alarm event and the selected one of the plurality of confidence levels.

### RELATED APPLICATIONS

This application claims the benefit of the filing date of U.S. provisional patent application No. 62/504,005, filed May 10, 2017, entitled “A Continuous Monitoring Security Management System and Method of Use”, the entire contents of which are incorporated by reference under 37 C.F.R. § 1.57.

### TECHNICAL FIELD

Embodiments of the present invention relate to alarm systems, and in particular to an alarm system for a home, building or campus environment that is continuously armed and that does not need to be armed or disarmed by a user as the user enters or exits the premises.

### BACKGROUND

Traditional alarm or security systems need to be manually activated or “armed” by a user in order for the system to trigger an alarm; correspondingly, the system needs to be manually “disarmed” by a user to deactivate the system to prevent a false alarm upon return. The system requires manual intervention to be effective. When not armed, the system will, at best, provide audible notification of a sensor trigger (e.g., beeping if a door is opened), and may provide ‘panic’ button connectivity to the call center. The manual arming and disarming of the system is onerous to many users, resulting in infrequent use or abandonment of the system altogether. When armed, the system blindly sends an alarm if a sensor is triggered without disarming within a prerequisite time. There is no determination of reasonableness (e.g., as when an alarm is triggered when an internal motion sensor is activated; however, none of the exterior windows or doors were opened), which lead to many false alarms. Even with smart home security monitoring and alert systems, there is still the notion of the system needing to be armed or disarmed; that is, the system must be actively armed to provide security.

New advances in the field have shifted the burden of arming and disarming from a manual operation to an automated one, owing to techniques such as monitoring of wireless sensor inputs, for example, geographical location (geolocation) of mobile devices through Global System for Mobile Communications (GSM) data, or detection of pre-paired wireless signals between on-person mobile devices and a security system's threshold monitoring device (e.g., wall-mounted security panel). However, the system must still be ‘armed’ to provide any security intrusion value, whether the arming is automated, manual, or a combination of the two.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1A is a flowchart of an embodiment of the invention;

FIG. 1B is a flowchart of an embodiment of the invention;

FIG. 1C is a flowchart of an embodiment of the invention;

FIG. 1D is a flowchart of an embodiment of the invention;

FIG. 1E is a flowchart of an embodiment of the invention;

FIG. 1F is a flowchart of an embodiment of the invention;

FIG. 2 is a state diagram in accordance with an embodiment of the invention;

FIG. 3 is an illustration of an environment in which an embodiment of the invention may operate.

FIG. 4 is a functional block diagram of the computing environment in which an embodiment of the invention may be implemented.

### DETAILED DESCRIPTION

Definitions

The detailed description references the following terms, as defined below.

Sensor

A sensor is a device, module, or subsystem whose purpose is to detect events or changes in its environment and send the information to other electronics, frequently a computer processor. A sensor is used with other electronics, from something as simple as a light to something as complex as a computer.

Sensors are the eyes and ears of a security system, providing a significant proportion of information about the state of a building, the position and status of various properties of the building and about the current occupancy of the building. The information provided by an individual sensor is at a point-in-time. Learning longer term trends from the sensor data is typically done by other components, such as a computer subsystem.

Embodiments of the invention categorize sensors into three classes: occupancy, alert and environmental. Some sensors can belong to more than one of these classes, in particular, depending on their manner of use.

Occupancy Sensor

Occupancy sensors are a class of sensors that provide embodiments of the invention with information about the current occupancy state of the building. An occupancy sensor is an indoor motion detecting device used to detect the presence of a person to automatically control operation of security, lighting, or temperature or ventilation systems for a building. Occupancy sensors may use infrared, ultrasonic, microwave, or other technology. The term encompasses devices as different as passive infrared (PIR) sensors, hotel room keycard locks and smart meters. The operating principles of an occupancy sensor take into consideration that all objects with a temperature above absolute zero emit heat energy in the form of radiation. Usually this radiation isn't visible to the human eye because it radiates at infrared wavelengths, but it can be detected by electronic devices designed for such a purpose. The term passive in this instance refers to the fact that PIR devices do not generate or radiate energy for detection purposes. They work entirely by detecting infrared radiation emitted by or reflected from objects. They do not detect or measure heat.

Embodiments of the invention contemplate a variety of occupancy sensor types, such as but not limited to:
PIR sensors, which work on heat difference detection, measuring infrared radiation. Inside the device is a pyroelectric sensor which can detect the sudden presence of objects (such as humans) who radiate a temperature different from the temperature of the background, such as the room temperature of a wall.
Environmental sensors, such as temperature, humidity, smoke and CO2 sensors, which detect the change in the environment due to the presence of a human.
Ultrasonic sensors, similar to radar, that work on the doppler shift principle. An ultrasonic sensor sends high frequency sound waves in an area and checks for their reflected patterns. If the reflected pattern is changing continuously then it assumes that there is occupancy. If the reflected pattern is the same for a preset time period then the sensor assumes there is no occupancy.
Microwave sensors, which are similar to the ultrasonic sensor, and also work on the doppler shift principle. A microwave sensor sends high frequency microwaves in an area and will check for their reflected patterns. If the reflected pattern is changing continuously then it assumes that there is occupancy. If the reflected pattern is the same for a preset time then the sensor assumes there is no occupancy. A microwave sensor has high sensitivity as well as detection range compared to other types of sensors.
Keycard light slots, used in a hotel energy management system to detect when a hotel room is occupied, by requiring the guest to place their keycard in a slot to activate systems such as lights, thermostats, and security.
Smart meters, which work by detecting the change in power consumption patterns that exhibit distinct characteristics for occupied and vacant states
Door operated switch.
Audio detection.
Biometric sensors, which measure and analyze unique physical or behavioral characteristics, such as fingerprint, facial features, voice, etc.
Siren.
Key fobs, which are a class of physical security tokens that includes smart cards, proximity cards and biometric keyless entry fobs. Hardware tokens are often small enough for one to store on a key ring, in their wallet or in their pocket.
Keypad PIN.
Exterior motion curtain sensor—typically a PIR sensor with a focused field of view, using infrared for heat detection of an object (e.g., person) otherwise obscured or hidden behind shrubbery and trees.
Camera motion detection.
Radiofrequency motion detection.
Remote control device infrared signal detection.
Initiation or discontinuation of wireless communications including but not limited to a bluetooth pairing, a wi-fi connection, or cellular communication.

Alert Sensor

An alert sensor is a class of sensor that provides notification of an event about a specific property of a building. In some cases, this alert may necessitate an immediate response by the system or user thereof. Alert sensors include:
Contact sensor. Contact sensors, which provide notification if something is open or closed. They're typically installed on doors, windows, drawers (including freezer drawer), valuables (a safe or jewelry box), a gate to a yard or swimming pool, throughout a building. They have two components: one installed on the door or window itself; the other installed next to it on the jamb or frame. When the door or window is opened and the components separate and move apart, the sensor signals ‘open’ to the security system. In embodiments of the invention, a contact sensor's status (open or closed) can generate real-time alerts that a door is opened or closed in the building.
Glass break sensor.
Water, water flow, flood detection sensor.
Heat, smoke, natural gas, and CO2 sensors.
Window frame thermostat.
Wireless (RF, wi-fi, cellular, Bluetooth) jamming, interception, rogue access point, wi-phishing, or amplification detection sensor.
Environmental sensors, which provide data about various local environmental properties in or near the building. Environmental sensors include thermostat sensors, humidity sensors, smoke and CO2 detection sensors.

Geofence/Geofencing

A geo-fence is a virtual perimeter for a real-world geographic area. A geo-fence can be dynamically generated, as in a radius around a point location, or a geo-fence can be a predefined set of boundaries (such as school zones or neighborhood boundaries). The use of a geo-fence is called geo-fencing, and one example of usage involves a location-aware device of a location-based service (LBS) user entering or exiting a geo-fence. This activity could trigger an alert to the device's user as well as messaging to the geo-fence operator. This information, which could contain the location of the device, could be sent to an application executing on a computer, a mobile telephone or to an email account.

Geofencing may be used to track location of a person, such as a young child, or a person afflicted with Alzheimer's disease, dementia, or memory loss, so someone can be notified if the tracked location of the person indicates the person is leaving or has left a designated area.

Geofencing allows users of the system to draw zones around places, such as places of work, customer's sites and secure areas. These geo-fences when crossed by an equipped vehicle or person can trigger a warning to the user or operator via a short message service (SMS) or e-mail. In some companies, geofencing is used by the human resource department to monitor employees working in special locations especially those doing field work. Using a geofencing tool, an employee is allowed to log his or her attendance using a GPS-enabled device when within a designated perimeter. Other geofencing applications include sending an alert if a vehicle is stolen and notifying authorities when wildlife stray into farmland or approach an area such as a campground.

Geofencing, in a security strategy model, provides security to wireless local area networks. This is done by using predefined borders (e.g., an office space with borders established by positioning technology attached to a specially programmed computer). The office space becomes an authorized location for designated users and wireless mobile devices.

Introduction

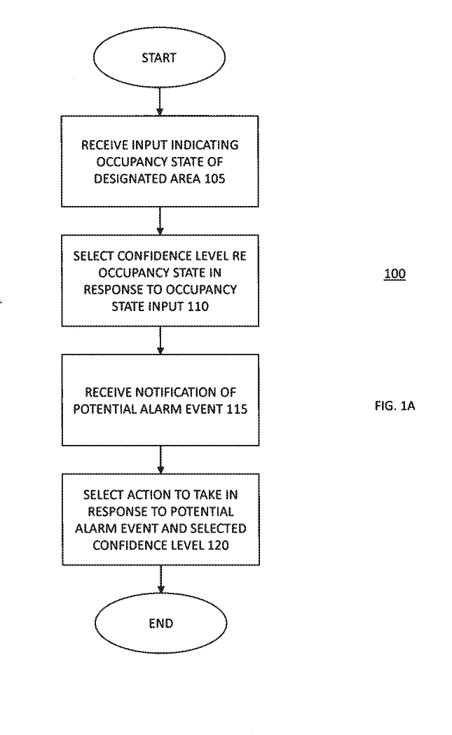

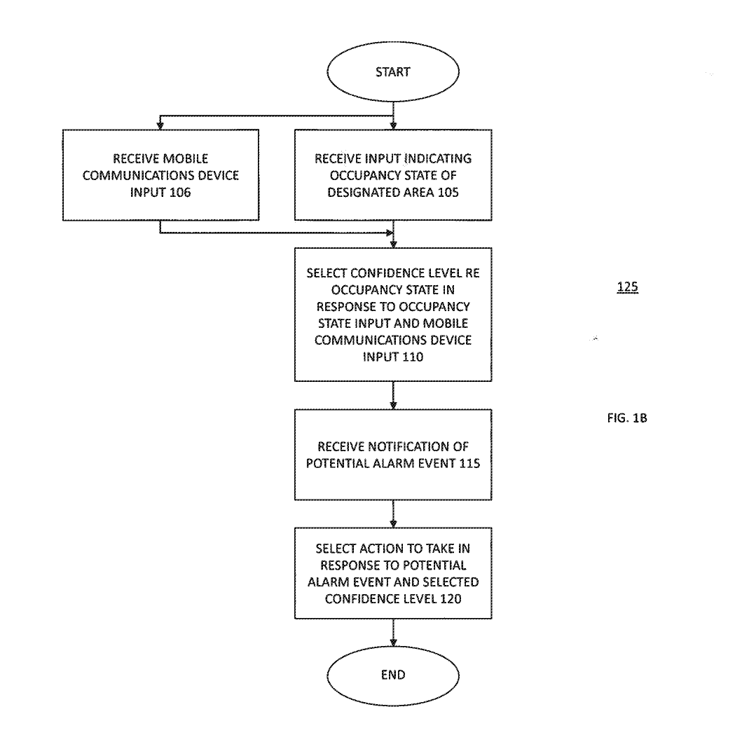

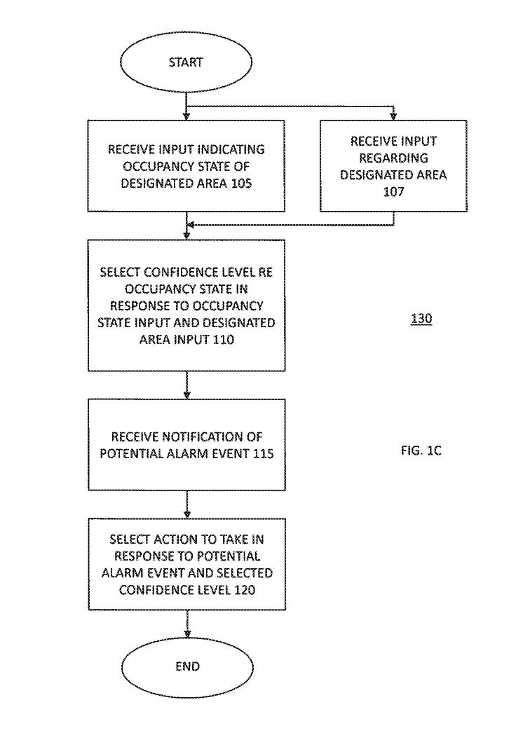

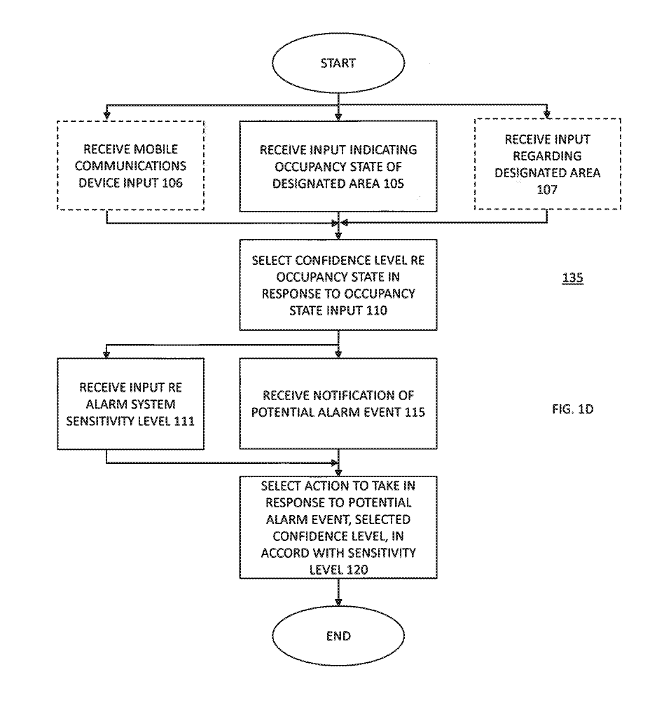

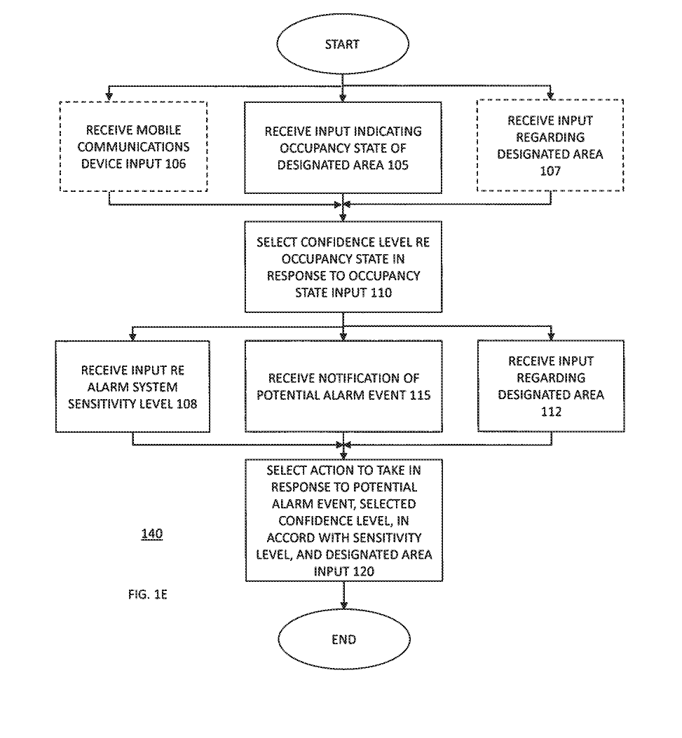

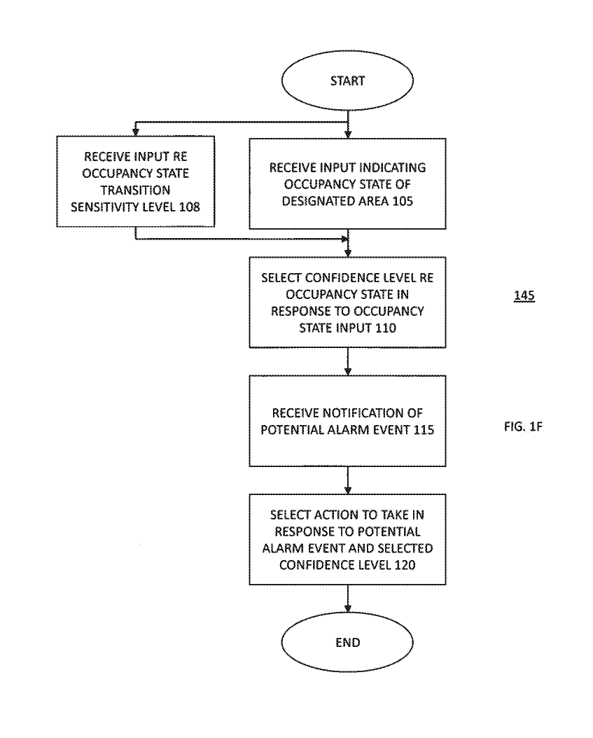

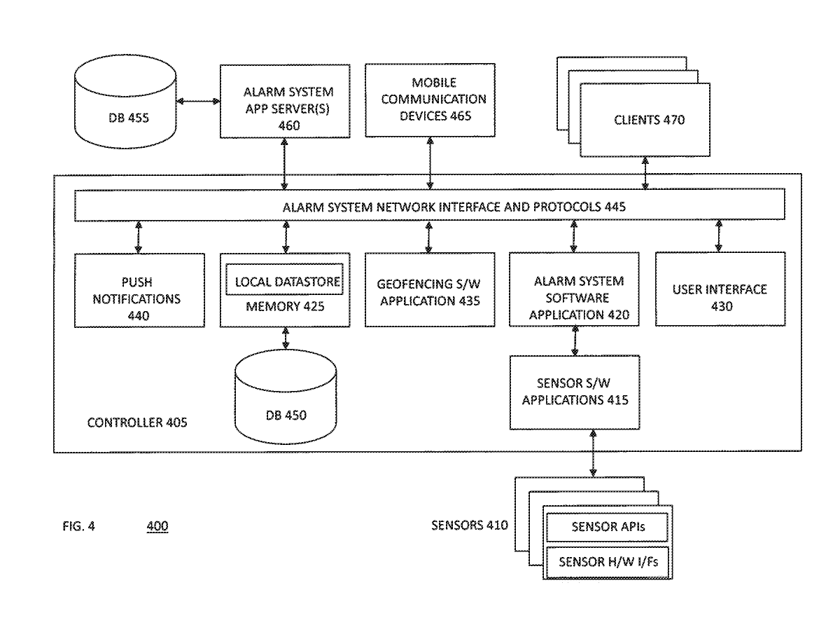

With reference to FIGS. 1A and 4, embodiments of the invention 100, 400 cause an alarm system to receive input at 105 indicating the occupancy state of, or for, a designated area, such as a house, a building, a gated community, a group of buildings, a campus, a public or private venue, a geo-fenced area, and combinations thereof. This input helps inform the alarm system of the likelihood that there are occupants in the designated area. Based on this input, the alarm system selects, at 110, a confidence level of the occupancy state for the designated area. In one embodiment, the confidence level is selected from one of a number of confidence levels regarding occupancy state of the designated area. The alarm system receives at 115 one or more notifications of a potential alarm event from one or more sensors 410 or mobile devices 465 situated within, and even around, the designated area. These sensors or mobile devices may be dedicated to the alarm system or may be independent devices with which the alarm system interacts. The alarm system selects at 120 an action to be taken based on one or more potential alarm events, and the selected confidence level. It is appreciated that the embodiments of the invention do not require a user or occupant to explicitly arm the alarm system. Rather, the embodiments continually monitor all the inputs, sensors or otherwise, and then pursue an action to be taken at a point in time, if any.

Detailed Written Description

In one embodiment, confidence levels may include a lowest confidence level, a low confidence level, a high confidence level, and a highest confidence level. The lowest confidence level may be defined or characterized as occupants on vacation or the designated area is empty/unoccupied, the low confidence level may be defined as the designated area is likely empty or unoccupied, the high confidence level may be defined as the designated area is likely occupied, and the highest confidence level may be defined as the designated area is, in fact, occupied. In other embodiments, there may be fewer or more confidence levels along a continuum from a lowest confidence level to a highest confidence level.

In one embodiment, the alarm system receives input indicating occupancy state of the designated area from, for example, a user interface 430, e.g., a keyboard or other input device and a monitor display or other output device coupled in communication with an alarm system controller 405, and/or from one or more sensors 410 and sensor software 415 executing thereon and/or therewith, and/or from one or more mobile communication devices 465.

In one embodiment, the user interface may be via a software application executing on a mobile communication device 465 or user interface 430 of the alarm system, or a programmable keypad and display coupled in communication with a sensor. The alarm system may receive input from authenticated individuals via one or more of these user interfaces.

In one embodiment, the sensors 410 indicating occupancy state of the designated area may be one of three basic types of sensors: an occupancy sensor, an alert sensor, an environmental sensor, or combinations thereof.

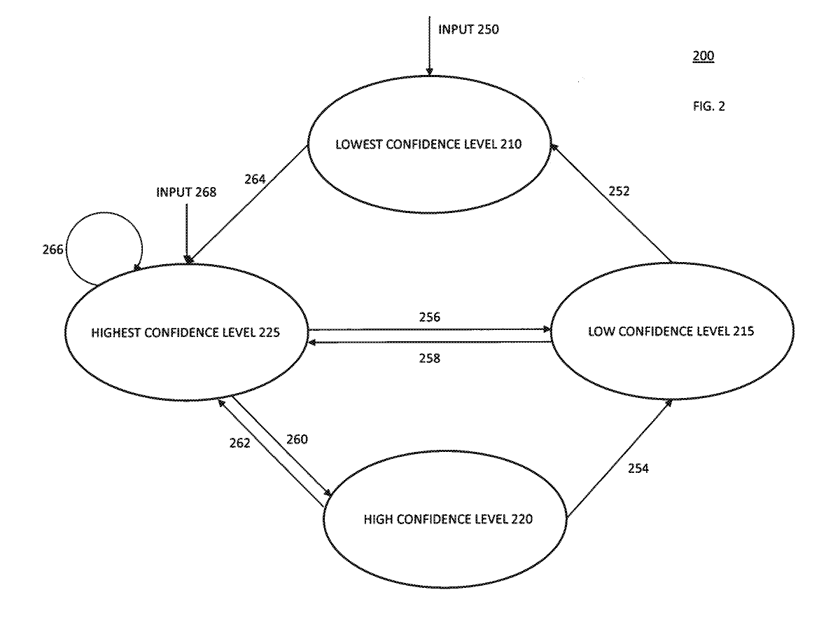

With reference to the state diagram 200 depicted in FIG. 2, selection of a confidence level for or of an occupancy state at 110 uses multiple inputs at 105, that is, the confidence level of whether one or more authenticated people are in a designated area, for example, whether a house is occupied or empty, is based on potentially numerous inputs. In this regard, authenticated people can be known users—users known to the alarm system, such as a home owner or other individuals that have an account with the alarm system, or guests—users not known to the alarm system, or unable to be identified, but their entry into the designated area was detected when another authenticated person was already present in the designated area. In one embodiment, the confidence level of occupancy state is a determination meant to be calculated on an on-going basis and used as an input in advance of the alert sensors.

The above enumerated confidence levels for occupancy states and the proposed inputs used to determine which confidence level for occupancy state is the current, or selected, confidence level is further described below.

The lowest confidence level of occupancy state 210 is selected when the designated area is clearly not occupied by authenticated users. This confidence level is entered by one of the following transitions.

1. By explicit command entered at 250 by an authenticated user, for example, via a user interface. This user may be authenticated by a pin, fingerprint biometrics or facial recognition detection. The confidence level 210 may be entered immediately or after a set time interval has elapsed.

2. By explicit command entered at 250 by an authenticated user, for example, via a mobile app, that all authenticated users are leaving the designated area. The confidence level 210 may be entered immediately or after a set time interval has elapsed.

3. An exit from the designated area is detected and the designated area appears empty. For example, an exterior door closes (regardless of the time interval between opening and closing the door, or whether a door open event was detected), there are no identified occupants present, no further motion is detected in the designated area for a time period specified by a configurable parameter, referred to herein as a sensitivity for no motion detection after exit parameter. The confidence level 210 is entered in this scenario at 252 as a transition from the low confidence level of occupancy state 215.

4. A lack of motion detection in the designated area, as happens when there are no identified occupants present in the designate area, and no motion has occurred for a time period specified by the configurable parameter such as the sensitivity for no motion detection after exit parameter. The confidence level 210 is entered in this scenario at 252 as a transition from the low confidence level of occupancy state 215.

The low confidence level of occupancy state 215 is selected when the designated area is likely not occupied by authenticated users. This confidence level is entered by one of the following transitions.

1. An exit from the designated area was detected and the designated area appears empty, such as when an exterior door closes (regardless of the time interval between opening and closing the door, or whether the open door event was detected), there are no identified users present, and no further motion is detected in the designated area for a minimum threshold portion (e.g., 50%) of the time period specified by the configurable sensitivity for no motion detection after exit parameter. This confidence level may be entered at 256 from the highest confidence level of occupancy state 225, or entered at 254 from the high confidence level of occupancy state 220.

2. Motion has not been detected for an extended period of time, which is characterized by no identified occupants present in the designated area, and no motion detection has occurred for a minimum threshold of a time period, e.g., 75% of the time period specified by a configurable parameter, referred to herein as the sensitivity for no motion detection for an extended period of time parameter. This confidence level may be entered at 254 from the high confidence level of occupancy state 220.

The high confidence level of occupancy state 220 is selected when the designated area likely is occupied by authenticated users. This confidence level is entered by the following transition: motion has not been detected for a moderate period of time, which is characterized by no identified occupants present in the designated area, and, since last entering the highest confidence level of occupancy state 225, no motion detection has occurred for a minimum threshold of a time period, e.g., 50% of the time period specified by the configurable sensitivity for no motion detection for an extended period of time parameter. This confidence level may be entered at 260 from the highest confidence level of occupancy state 225.

The highest confidence level of occupancy state 225 is selected when the designated area is occupied by one or more authenticated users. This confidence level is entered by one of the following transitions.

1. A location for a mobile communications device indicates that an individual is very close to, or in, the designated area, characterized by a least one authenticated user's mobile communication device (e.g., mobile phone) has been detected in the designated area, e.g., connected to a home's local area wireless network, or connected via Bluetooth to the alarm system, and/or at least one user's mobile communications device reported entering a geofence erected around the designated area, e.g., a home's exterior. This confidence level may be entered at 262 from the high confidence level of occupancy state, at 258 from the low confidence level of occupancy state 215, or at 264 from the lowest confidence level of occupancy state 210.

2. Authentication by a user via a user interface for the alarm system, e.g., a display panel for the alarm system. For example, an authenticated user may enter an explicit command at 268 via the user interface. The user may be authenticated by a pin, fingerprint biometrics or facial recognition detection. The confidence level 225 may be entered immediately or after a set time interval has elapsed. This confidence level may also be entered at 262 from the high confidence level of occupancy state, at 258 from the low confidence level of occupancy state 215, or at 264 from the lowest confidence level of occupancy state 210.

3. Recent motion is detected in the house, characterized by, since last entering this state, motion being detected within a minimum threshold of time, e.g., half of the time period specified by the configurable sensitivity for no motion for an extended period of time parameter. This confidence level is entered at 266 from the highest confidence level of occupancy state, or at 262 from the high confidence level of occupancy state 220.

One embodiment of the invention further contemplates tracking one or more identified users (“identified user tracking”). For each user identified in the designated area, the alarm system attempts to track their presence. An identified user's presence is set to “away” from the designated area when the alarm system transitions to the lowest confidence level of occupancy state 210 and presumes all individuals are no longer on the designated premises (e.g., no longer in in the house).

An identified user's presence may also be set to “away” from the designated area when the user's mobile communication device's location explicitly indicates the identified user is not in the designated area, including, for example, when the mobile communication device was, but no longer is, connected to a local Wi-Fi or Bluetooth network within or encompassing the designated area, or the identified user's mobile communication device, since the time the identified user was detected as in the designated area, is now reporting live geolocation information that indicates the identified user is away from the designated area. An identified user's presence may also be set to “away” from the designated area when schedule guidance/inputs from an authenticated user, e.g., a home owner, explicitly flag an identified user's mobile communications device as off line, powered off, or otherwise not reliable, or indicate the user has left the designated area. Finally, an identified user's presence may also be set to “away” from the designated area when the identified user has been authenticated by another alarm system that is physically separate from this alarm system.

An identified user's presence is set to “present” in the designated area upon a successful authentication of the identified user at a user interface of the alarm system, such as at a panel or keypad inside or at the security perimeter of the designated area. Likewise, an identified user is marked as “present” in the designated area when their mobile communication device's geolocation information indicates the user is very close to, or within the designated area, such as when the mobile communication device is detected within the designated area, e.g., connected to a local wireless network, or a Bluetooth radio connection with the alarm system, of the mobile communication device reports entering a geofence erected around the perimeter of the designated area (e.g., the exterior of a home).

With reference to FIGS. 1B and 4, one embodiment of the invention 125, 400 receives additional input in the form of geofencing or geolocation information transmitted from one or more mobile communication devices 465 within or around the designated area. In one embodiment, a geofencing software application executing on the controller receives this additional input. In this embodiment, the alarm system selects one of the confidence levels regarding occupancy state of the designated area further based on the received additional input. In this embodiment, the alarm system receives input at 105 indicating the occupancy state of the designated area, as well as geolocation information input from mobile communication devices at 106. Based on these inputs, the alarm system selects, at 110, the confidence level. The alarm system receives at 115 one or more notifications of a potential alarm event from one or more sensors 410 or mobile devices 465 situated within or around the designated area. The alarm system then selects at 120 an action to be taken based on one or more potential alarm events, and the selected confidence level.

In one embodiment, the mobile communication devices are cellular communications capable mobile devices. In other embodiments, the devices may support or adhere to other wireless communication protocols or standards such as an IEEE 801.11 Wi-Fi communications, Bluetooth wireless communications technology, and global positioning satellite (GPS) communications standards, and communicate geofencing or geolocation information with a geofencing application 435 of the alarm system 400.

With reference to FIGS. 1C and 4, one embodiment of the invention 130 receives additional input or otherwise learns about information relevant to or about the designated area at 107, wherein the additional input or learned information is, for example, one or more of: time of day, learned occupancy schedule (work/school/other of various occupants), pattern of where and/or when mobile communication devices are present (based on such devices being on the person of an occupant within the designated area), in or absent from, the designated area, day of week, building service personnel on-site patterns, seasonal-, holiday-, or personal observances of various occupants, current weather conditions, adverse and/or extreme weather conditions. This information could be explicitly input at one or more of user interface 430, received via sensors 410, or received via mobile communication devices 465. In this embodiment, the alarm system selects one of the confidence levels regarding occupancy state of the designated area further based on the received additional input. In this embodiment, the alarm system receives input at 105 indicating the occupancy state of the designated area, as well as receives input regarding additional relevant information about the designated area, at 107. Based on these inputs, the alarm system selects, at 110, the confidence level. The alarm system receives at 115 one or more notifications of a potential alarm event from one or more sensors 410 or mobile devices 465 situated within or around the designated area. The alarm system then selects at 120 an action to be taken based on one or more potential alarm events, and the selected confidence level.

The additional input about information relevant to or about the designated area received at 107 can be thought of as learned behavior qualifiers to the input received at 105, for example, from sensors 410.This information may be considered and provided as a weighting to the occupancy state. Specifically, in one embodiment, the weighting that is applied to the occupancy state of the designated area is a level of confidence that the occupancy is expected, anticipated or otherwise behavior that has been learned by the system to be considered normal (“Learned Behavior Confidence”, or “LBC”). The learned behavior confidence, in one embodiment, is a value that ranges from 0 to 100, where 0 represents no confidence that the occupancy state is expected, anticipated or otherwise normal, up to where 100 represents that occupancy state is completely expected, anticipated or otherwise normal.

An embodiment of the invention can consider the learned behavior confidence when selecting the confidence level at 110, and elevate or reduce the selected confidence level 110.

The following description enumerates learned behavior qualifiers and how each may impact the value of the learned behavior confidence weighting:

Time of day: if the occupancy state occurred and during the last time period (e.g., 30 days—adjustable time period) there was a similar occupancy state (same target and target area) during the same time window (half hour before and after—adjustable window) then the LBC is weighted with the number of days this occurred out of the time period.

Learned schedule (work/school/other): pattern of when mobile communication devices are present or absent from the designated area/day of week. If the indicated occupancy state occurs while the confidence level regarding the occupancy state is currently at its lowest confidence or low confidence level, and during the last time period (30 days—adjustable time period) there were: one or more mobile communication devices present on at least three of the preceding same day of the week, or confidence level regarding the occupancy state for the designated area was at the highest level on at least three of the preceding same days of the week, then the LBC is set to the percentage with the number of days that the behavior was present on this specific day of the week in the last preceding 6-month time window.

Service personnel patterns: this is handled in a manner similar to the above described learned schedule.

Seasonal observances and/or holidays—discount the learned schedule. In one embodiment, these items cause the learned schedule to not be applied, or may reduce the weighting by it a certain percentage.

Adverse current weather conditions, extreme temperature: if the occupancy state occurs while the confidence level of the occupancy state is currently at the lowest confidence level or low confidence level, and the current weather conditions are currently abnormal (tornado, blizzard, etc.) or the temperate can be considered extreme for the area (either cold or hot extremes), then set LBC to 50 percent on the assumption that individuals may be in the designated area (e.g., a house) that otherwise would be outside or working.

In the above described embodiments illustrated in the flow charts of FIGS. 1A-1C, the step of receiving notification of a potential alarm event from one or more of a number of sensors at 115 contemplates using sensor inputs from the sensors monitoring the designated area to determine an potential alarm event that is occurring in, around or outside of the designated area at a current point in time. Potential alarm events may be triggered through a single sensor input, or a more complex layering of potential alarm events over a short period of time. Further, in some embodiments, there may be more than one potential alarm event under evaluation or construction at a point in time, though not all necessarily are confirmed as actual alarm events.

In one embodiment, potential alarm events are not based on, and do not accept, user input. Any user input is requested and handled in determining or selecting the action to be taken in response to the potential alarm event and selected confidence level. After receiving and processing user input, some actions to take in response to one or more potential alarm events may require additional clarification through waiting for additional sensor data. It is contemplated that this process will be handled according to, and as part of, the particular action to be taken.

Embodiments of the invention are able to combine a number of sensors, or sensor inputs, typically in a progressive manner, to obtain a more nuanced view of the potential alarm event. In one embodiment, as a baseline, the alarm system monitors a single sensor. Typically, this is a perimeter sensor, such as a door or window sensor. Given the binary nature of this sensor input, it is not possible to further understand a potential alarm event in this situation other than as a singular open/close event. However, by combining multiple sensors, or sensor inputs, embodiments are able to obtain a greater understanding of the potential alarm event. For example, combining an external motion sensor with a door or window contact may allow an embodiment to ascertain that there is a building envelop penetration that originated from outside the building. With this greater understanding, more nuanced action(s) can be taken for this potential alarm event. Further, it may be possible to deduce potential alarm events when a primary sensor is either not present, unmonitored, or in an open or unknown state. As an example, it is common to leave open a window or door. Typically, it would not be possible to monitor entry of a person through the opening in this situation. However, combining exterior and interior motion detectors on either side of the open window or door allows the alarm system to follow motion from the outside, through the building envelop, and into the interior. The alarm system is then able to provide a nuanced response in terms of the action to be taken, such as alerting a home owner that someone may have entered the home through the open window.

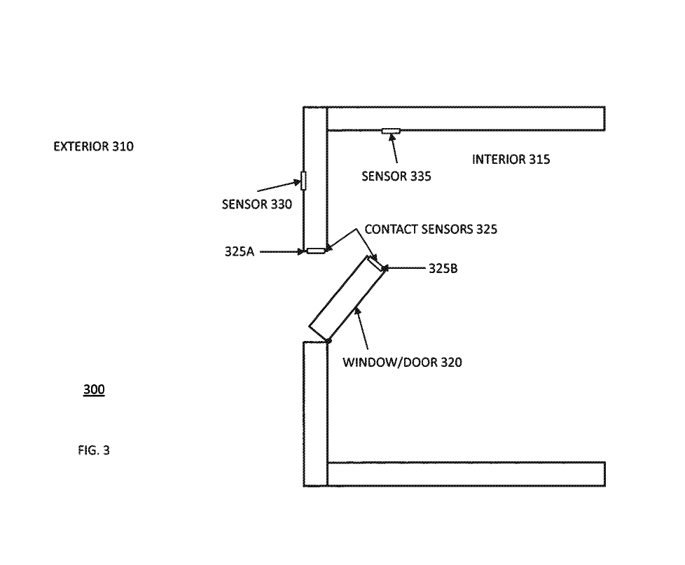

As an example, with reference to FIG. 3, in one embodiment 300, a designated area, in this case, the interior 315 of a building, is set up to be monitored for potential alarm events. Note that window or door 320 is open. Typically, it is not possible to monitor entry of a person through this opening in this situation even though contact sensor 325 is installed, including both a sensor 325A on the door or window jamb, and a counterpart sensor 325B on the side or edge of the door or window. However, combining exterior sensor 330 (e.g., a motion detection sensor or video camera) and interior sensor 335 (e.g., a motion detection sensor or video camera) on respective sides of the open window or door allows the alarm system to follow motion from the outside, through the building envelop, and into the interior. The alarm system is then able to provide a nuanced response in terms of the action to be taken, such as alerting a home owner that someone may have entered the home through the open window.

Further in regard to the above described embodiments illustrated in the flow charts of FIGS. 1A-1C, the step of receiving notification of a potential alarm event from one or more of a number of sensors at 115 includes receiving notification of one or more of the following enumerated potential alarm events:
a typical entry door opened from inside,
a typical entry door opened from outside,
a typical entry door opened,
a non-typical entry door opened from inside,
a non-typical entry door opened from outside,
a non-typical entry door opened,
a non-used entry door opened from inside,
a non-used entry door opened from outside,
a non-used entry door opened,
a possible entry through closed window,
a possible entry through open door,
a window opened from inside,
a window opened from outside,
a window opened,
a possible entry through open window,
a cabinet or drawer opened,
a interior motion sensed,
an exterior motion sensed,
an exterior casing event detected,
a glass breaking detected,
a flood/water detected,
smoke detected, and
CO2 gas detected.

A brief description of each potential alarm event follows.

The typical entry door opened from inside: the criteria for detecting this potential alarm event, with doorway (“Doorway”) limited to exterior doorways that have been marked as typically utilized by the users for home ingress or egress, includes motion being detected in an interior area (“Target Area”) that contains one or more Doorways, and within a period of time thereof (e.g., 2 minutes), in the Target Area, a door contact that is attached to a Doorway transitions from closed to open (“Target”).

The typical entry door opened from outside: the criteria for detecting this potential alarm event, with doorway (“Doorway”) limited to exterior doorways that have been marked as typically utilized by the users for home ingress or egress, includes motion being detected in an exterior (“Target Area”) that is associated with one or more Doorways, and within a period of time thereof (e.g., 2 minutes), in the Target Area, a door contact that is attached to a Doorway transitions from closed to open (“Target”).

The typical entry door opened: the criteria for detecting this potential alarm event, with doorway (“Doorway”) limited to exterior doorways that have been marked as typically utilized by the users for home ingress or egress, a door contact that is attached to a Doorway transitions from closed to open (“Target”), and simultaneous to the Target activating, if motion is detected in an interior area (“Target Area”) that contains the Target, then also note the Target Area but do not attempt to elevate the event to Typical entry door opened from inside. This is due to the potential of the door swinging open, or a person or object traversing the doorway triggering the interior motion sensor. Note that neither “typical entry door opened from inside” or “typical entry door opened from outside” are in consideration in this event.

The non-typical entry door opened from inside: the criteria for detecting this potential alarm event is the same as the “typical entry door opened from inside”, with doorway (“Doorway”) limited to exterior doorways that have been marked as not typically or seldom utilized by the users for home ingress or egress.

The non-typical entry door opened from outside: the criteria for detecting this potential alarm event is the same as the “typical entry door opened from outside”, with doorway (“Doorway”) limited to exterior doorways that have been marked as not typically or seldom utilized by the users for home ingress or egress.

The non-typical entry door opened: the criteria for detecting this potential alarm event is the same as the “typical entry door opened”, with doorway (“Doorway”) limited to exterior doorways that have been marked as not typically or seldom utilized by the users for home ingress or egress.

The non-used entry door opened from inside: the criteria for detecting this potential alarm event is the same as the “typical entry door opened from inside”, with doorway (“Doorway”) limited to exterior doorways that have been marked as not utilized by the users for home ingress or egress.

The non-used entry door opened from outside: the criteria for detecting this potential alarm event is the same as the “typical entry door opened from outside”, with doorway (“Doorway”) limited to exterior doorways that have been marked as not utilized by the users for home ingress or egress.

The non-used entry door opened: the criteria for detecting this potential alarm event is the same as the “typical entry door opened”, with doorway (“Doorway”) limited to exterior doorways that have been marked as not utilized by the users for home ingress or egress.

The possible entry through open door: the criteria for detecting this potential alarm event includes detecting motion in an exterior area (“Target Area”) that contains one or more exterior doors that are currently reporting back open, and within a period of time thereof, e.g., 30 seconds, in the Target Area, motion is detected in an interior area that contains the Target.

The window opened from inside: the criteria for detecting this potential alarm event includes detecting motion in an interior area (“Target Area”) that contains one or more exterior windows, and within a period of time thereof, e.g., 2 minutes, in the Target Area, a window contact that is attached to an exterior window transitions from closed to open (“Target”)

The window opened from outside: the criteria for detecting this potential alarm event includes detecting motion in an exterior area (“Target Area”) that contains one or more exterior windows, and within a period of time thereof, e.g., 2 minutes, in the Target Area, a window contact that is attached to an exterior window transitions from closed to open (“Target”).

The window opened: the criteria for detecting this potential alarm event includes a window contact that is attached to an exterior window transitioning from closed to open (“Target”).

The possible entry through closed window: the criteria for detecting this potential alarm event includes detecting motion in an exterior area (“Target Area”) that contains one or more exterior windows that are currently reporting back closed, and within a period of time thereof, e.g., 2 minutes, in the Target Area, a window contact that is attached to an exterior window transitions from closed to open (“Target”), and within another period of time thereof, e.g., 30 seconds, in the Target Area, motion is detected in an interior area that contains the Target.

The possible entry through open window: the criteria for detecting this potential alarm event includes detecting motion in an exterior area (“Target Area”) that contains one or more exterior windows (“Target”) that are currently reporting back open, and within a period of time thereof, e.g., 30 seconds, in the Target Area, motion is detected in an interior area that contains the Target.

The cabinet opened: the criteria for detecting this potential alarm event includes a cabinet contact that is attached to a cabinet transitioning from closed to open (“Target”).

The interior motion detection sensed: the criteria for detecting this potential alarm event involves detecting motion in an interior area (“Target Area”).

The exterior motion sensed: the criteria for detecting this potential alarm event includes detecting motion in an exterior area (“Target Area”).

The exterior casing: the criteria for detecting this potential alarm event includes detecting motion in an exterior area (“Target Area”), and within a period of time thereof, e.g., 2 minutes of the last detected Target Area; motion is subsequently detected in another exterior area immediately adjacent to the Target Area; and at least 30%, or at least 3, unique exterior motion sensors are triggered.

With regard to the step of selecting an action to be taken responsive to the potential alarm event and the selected confidence level 120, action to be taken represents the action that could be taken by the alarm system in response to the occurrence of a specific potential alarm event in the designated area in a given confidence level of an occupancy state. The action to be taken may range from no action to be taken, through a simple, single-step response, up to a multi-step response that requires further interaction with multiple parties such as an unidentified person (a possible intruder), owner(s) of the designated area, or alarm event responders. In one embodiment, actions to be taken are ranked from highest to lowest priority. An action to be taken typically is atomic, meaning that it should be completed to its conclusion. The exception to this is when a higher ranked actions is required by the alarm system, in which case a lower priority action may be suspended in favor of the higher priority action.

Further with regard to the step of selecting an action to be taken responsive to the potential alarm event and the selected confidence level, one embodiment of the invention contemplates selecting one of the following actions:

No response: the potential alarm event is either considered a normal event in the designated area, or otherwise does not warrant notification to or interaction with users. No action is to be taken.

Challenge an individual for authentication: an unknown or unidentified individual has triggered a potential alarm event. This action challenges the individual to identify themselves and elevate the action to be taken if necessary.

If the learned behavior confidence is at or exceeds some threshold, e.g., 80, then send a notification to all adult users of the alarm system that the following LBC action, or actions are happening and are going to auto-authenticate based on LBC details. The adult users can then confirm or deny the LBC choice.

Broadcast on all connected display panels a request for the individual to identify themselves at a user interface to the alarm system, e.g., at a display panel.

Broadcast to all locally connected mobile communication device applications a notification that an unidentified person may have entered and that authentication is required.

If unanswered after a timeout period, e.g., 20 seconds, repeat request.

If unanswered after 20 additional timeout period, then elevate the action to be taken:
If the learned behavior confidence is above a moderate threshold, e.g., 50 or above, then send a notification to all adult users of the alarm system that an unidentified individual has entered the designated area, giving the reason behind the LBC. An adult user can then confirm or deny the LBC choice.
Otherwise, elevate the action to be taken to “raise an alarm” and follow through on such actions.

Passively notify designated area (e.g., house) occupants: the corresponding potential alarm event, while a normal event in the house, is at a high enough priority that it warrants notifying the occupants in a passive manner.

Broadcast on all connected user display panels or local mobile communication device applications a passive notification that neither requires a user to respond nor interrupts any current user interface flow. The passive notification may be one of the following, depending on the current settings of the user interface and each individual mobile app: sound a chime; display a toast, or other like temporary text notification, that contains the main event detail, or pulse the area on an avatar of the designated area where the event occurred.

Notify the designated area (e.g., home) owner: the corresponding potential alarm event, while a normal event in the house, is at a high enough priority that it warrants notifying only the owner (“target users”) of the event. The notification is delivered in a way that the information is available if needed, but doesn't impact the user's workflow. Typically, the notification needs to be acknowledged or dismissed by the user.

Broadcast on all connected panels a notification that doesn't requires the user's response: display a toast, or other like temporary text notification, that contains the main event details; pulse the area on the house avatar where the event occurred.

Broadcast to all target users' mobile apps a notification. Typically, such notification would be delivered by the alarm system's push notification service 440.

Notify the adult users of the house: this selected action to be taken is the same as described herein for notifying the owner of the designated area (e.g., home owner) with the notifications delivered to all adult users of the house (“target users”).

Notify all users of the house: this selected action is the same as described herein for notifying the owner of the designated area, with the notifications delivered to all users of the designated area (“target users”).

Send an alert to the trusted group: the corresponding potential alarm event is at a high enough priority that it warrants notifying a trusted group of individuals that the owner of the designated area has previously identified (“target users”).

Note that the Target Users may not necessarily be users of the alarm system, according to an embodiment. For example, one embodiment can bring a mobile app to the foreground with an alert message, potentially ringing as a telephony app. For all contact numbers not associated with an active mobile app device, or for apps that do not confirm that the app transitioned to the foreground, one embodiment may initiate a call to the target user's contact numbers.

Send an alert to the wider social neighborhood: the corresponding potential alarm event is significant enough to warrant also notifying a wider social group, either through the neighborhood-based software application or other third party services. Broadcast on all social groups connected to the designated area an alert on the given potential alarm event. No response is required.

Raise an alarm: this action to be taken is a critical response to an active threat situation. Depending on the level of service, the following may be relevant:
if central station monitoring is subscribed, then send a threat message to the appropriate central station;
if the confidence level of the occupancy state is at the lowest level (e.g., homeowner input to UI that s/he is on vacation), then raise an alarm to a delegated trusted group, if any;
raise an alarm to the designated area (home) owner;
if the home owner does not respond to the alarm, raise an alarm to all other adult users of the designated area; and
sound the siren installed in the designated area.

Raising an alarm involves taking active steps to ensure that the target users are contacted, including causing a mobile app come to the foreground with an alert message, potentially ringing as a telephony app, and for all contact numbers not associated with an active mobile app device, or for apps mentioned above that did not confirm that the app transitioned to the foreground, an embodiment initiates a call to the target user's contact numbers.

It is appreciated, as shown in the flow diagram of FIG. 1D, that the embodiments illustrated FIGS. 1A-1C can be optionally combined in any manner. FIG. 1D further demonstrates an additional embodiment, in which the alarm system receives input regarding a sensitivity level for the alarm system at 111. Thus, the embodiment proceeds as generally described above: the alarm system selects one of the confidence levels regarding occupancy state of the designated area based on input received at 105 indicating the occupancy state for a designated area, optionally further based on the received geofencing or geolocation information transmitted from one or more mobile communication devices 465 within or around the designated area at 106, and optionally further based on the received additional input about information relevant to or about the designated area at 107. Based on one or more of these inputs, the alarm system selects, at 110, the confidence level. The alarm system receives at 115 one or more notifications of a potential alarm event from one or more sensors 410 or mobile devices 465 situated within or around the designated area. In this embodiment, some time prior to selecting the action to be taken responsive to the potential alarm event and the selected confidence level, the alarm system receives input regarding the sensitivity level for the alarm system at 111. Then the system selects the action to be taken at 120 further responsive to the received sensitivity level for the alarm system. In one embodiment, the alarm system receiving input regarding the sensitivity level for the alarm system comprises receiving machine-learned input and/or user input, for example, user input via the user interfaces described above, regarding the sensitivity level for the alarm system.

It is appreciated that home owners will differ in the level of protection that they wish to receive from the system and in the aggressiveness of the interactions and actions provided in response to potential alarm events. The sensitivity level of the alarm system may either be explicitly set by or solicited from a user, in one embodiment. The alarm system sensitivity levels vary from low to aggressive, and may be enumerated, such as: low, balanced, and aggressive.

With reference to FIG. 1E, one embodiment of the invention receives additional input at 112 relevant to or about the designated area or thereabout, for example, time of day, learned occupancy schedule (work/school/other), pattern of where and/or when mobile phones are present, in or absent from, the designated area, day of week, building service personnel on-site patterns, seasonal-, holiday-, or personal observances, current weather conditions, adverse and/or extreme weather conditions. In this regard, this step is similar to step 107 in which similar information is gathered either via user input, via sensors 410, or via mobile communication devices 465. However, in this embodiment, this information, rather than being used by the alarm system to select one of the confidence levels regarding occupancy state of the designated area, is being used by the alarm system to select the action to be taken further responsive to the received additional input. It is appreciated that this information being used in steps 107 and 112 need only be gathered once, and the information can then be used by one or both steps. The information can be stored in a database 450, accessed and read into a local datastore in memory 425 and used by the alarm system software application 420 to perform steps 110 and/or 120.

The additional input about information relevant to or about the designated area received at 107 can be thought of as learned behavior qualifiers to the input received at 105, for example, from sensors 410. This information may be considered and provided as a weighting to the potential alarm events as discussed herein. Specifically, in one embodiment, the weighting that is applied to the potential alarm event is a level of confidence that the potential alarm event is expected, anticipated or otherwise behavior that has been learned by the system to be considered normal (“Learned Behavior Confidence”, or “LBC”). The learned behavior confidence, in one embodiment, is a value that ranges from 0 to 100, where 0 represents no confidence that the potential alarm event is expected, anticipated or otherwise normal, up to where 100 represents that the potential alarm event is completely expected, anticipated or otherwise normal.

An embodiment of the invention can consider the learned behavior confidence when selecting the action to be taken at 120, and elevate or reduce the intensity of the action to be taken.

The following description enumerates learned behavior qualifiers and how each may impact the value of the learned behavior confidence weighting:

Time of day: if the potential alarm event occurs and during the last time period (e.g., 30 days—adjustable time period) there was a similar potential alarm event (same target and target area) during the same time window (half hour before and after—adjustable window) then the LBC is weighted with the number of days this occurred out of the time period.

Learned schedule (work/school/other): pattern of when mobile communication devices are present or absent from the designated area/day of week and/or learned pattern of occupancy establishment. If the indicated potential alarm event occurs while the confidence level regarding the occupancy state is currently at its lowest confidence or low confidence level, and during the last time period (30 days—adjustable time period) there were: one or more mobile communication devices present on at least three of the preceding same day of the week, or confidence level regarding the occupancy state for the designated area was at the highest level on at least three of the preceding same days of the week,
then the LBC is set to the percentage with the number of days that the behavior was present on this specific day of the week in the last preceding 6-month time window.

Service personnel patterns: this is handled in a manner similar to the above described learned schedule.

Seasonal observances and/or holidays—discount the learned schedule. In one embodiment, these items cause the learned schedule to not be applied, or may reduce the weighting by it a certain percentage.

Adverse current weather conditions, e.g., extreme temperature: if the occupancy state occurs while the confidence level of the occupancy state is currently at the lowest confidence level or low confidence level, and the current weather conditions are currently abnormal (tornado, blizzard, etc.) or the temperate can be considered extreme for the area (either cold or hot extremes), then set LBC to 50 percent on the assumption that individuals may be in the designated area (e.g., a house) that otherwise would be outside or working.

With regard to FIG. 1F, one embodiment of the invention receives input selecting an occupancy state transition sensitivity level at 108. The alarm system then selects the confidence level regarding occupancy state of the designated area further in response to the selected occupancy state transition sensitivity level. In one embodiment, the occupancy state transition sensitivity level may be selected as one of the following: a lowest sensitivity level, a low sensitivity level, a moderate sensitivity level, a high sensitivity level, and a highest sensitivity level. Thus, this embodiment may proceed as generally described above, but further including the step of the alarm system selecting one of the confidence levels regarding occupancy state of the designated area based on the selected occupancy state transition sensitivity level, in addition to input received at 105 indicating the occupancy state for a designated area, optionally further based on the received geofencing or geolocation information transmitted from one or more mobile communication devices 465 within or around the designated area at 106, and optionally further based on the received additional input about information relevant to or about the designated area at 107.

In this embodiment, selecting the confidence level regarding occupancy state of the designated area further based on the selected occupancy state transition sensitivity level affects the time at which the alarm system switches to the selected confidence level. To that end, each occupancy state transition sensitivity level is associated with a schedule or period of time to delay or wait before transitioning to the selected confidence level regarding occupancy state of the designated area. In this embodiment, the alarm system optionally receives input regarding learned behaviors of individuals that have occupied the designated area, and adjusts the associated schedule for transitioning to the selected confidence level regarding occupancy state of the designated, based thereon. In such an embodiment, the confidence level is selected according to the adjusted associated schedule for transitioning to the selected confidence level regarding occupancy state of the designated area.

Ideally, the alarm system transitions between occupancy states with perfect and complete information and immediately following an occupant's actions or other relevant system input, sensor or otherwise. In practice, according to one embodiment, the alarm system may delay transitioning to a new occupancy state for a period of time in order to gain confidence regarding an occupant's actions, with an appreciation that reducing the time required to transition from one occupancy state to another occupancy state is beneficial. In this embodiment, the sensitivity level of the alarm system with respect to occupancy state transitions is first set through an occupancy state transition sensitivity level which is either explicitly set by or solicited from a user. The occupancy state transition sensitivity levels vary from lowest to highest, as enumerated above. The selected occupancy state transition sensitivity levels map to a timeout which this embodiment uses before transitioning to another occupancy state. Each specific use of the occupancy state transition sensitivity level has its own unique set of timeouts, tailored to the specific transition, and are defined as set forth below.

In one embodiment, following an initial timeout value, there can be one or more optional learned behaviors that the alarm system can calculate and use to reduce the timeout. Like the initial occupancy state transition sensitivity level, these learned behaviors reduce the timeout in a specific way for each unique use.

Occupancy State Transition Sensitivity Level for No Motion Detection After Exit

After a potential exit of an individual from the designated area has been detected, the embodiment waits for a certain period of time before transitioning from the highest confidence level of occupancy state. Table 1, below, suggests the time period to wait parameter, according to an embodiment.

TABLE 1
Occupancy state transition sensitivity level for no motion detection
after exit

| Occupancy state | Time to wait after |
|---|---|
| transition sensitivity level | exit detected |
| Lowest | 8 hours |
| Low | 4 hours |
| Moderate | 1 hour |
| High | 30 minutes |
| Highest | 15 minutes |

The following learned behaviors can be calculated and reduce the time to wait value. A histogram of previous activity strongly suggests that all owners or managers of the designated area (e.g., home owners) are away during this time window. For example, over the past recent time period (e.g., 30-day history, current day of the week, 60-day history, or bi-weekly current day of week), the designated has been unoccupied during this same time window (plus or minus 15 minutes from the current time). In this situation, if the value of the time to wait parameter is:
greater than a first minimum threshold of time (e.g., 95%), then set the value of the time to wait parameter to the highest value; or
greater than a second minimum threshold of the time (e.g., 80%) which is less than the first minimum threshold of time, then reduce the time to wait parameter to half of the current value.

The following learned behaviors can be calculated to increase or otherwise adjust the value of the time to wait parameter. A histogram of previous activity strongly suggests that the designated area is occupied or likely occupied only by one or more unidentified occupants (for example, people not positively tracked by identified user tracking as described elsewhere herein). For example, over the past recent time period (e.g., 30-day history, current day of the week, 60-day history, or bi-weekly current day of week), an exit event was detected during this same time window (plus or minus 15 minutes from the current time) and the designated area subsequently had an internal motion detection event (a “triggering motion event”) that caused a transition from a confidence level of occupancy state of low confidence, high confidence, or highest confidence to the highest confidence level of occupancy state. In this situation, if the value of the time to wait parameter is:
greater than a first minimum threshold of the time (e.g., 95%) then set the value of the time to wait parameter to an interval of time between now and the average triggering motion event; or
greater than a second minimum threshold of time, which is less than the first minimum threshold of time (e.g., 70%), then increase the value of the time to wait parameter to an interval of time between now and the average triggering motion event.

Occupancy State Transition Sensitivity Level for No Motion for Extended Period

After a long period of inactivity in the designated area, the alarm system, according to one embodiment, may begin to build a level of confidence that all occupants have left and the designated area is now empty. Table 2 below sets out the time period to wait.

TABLE 2
Occupancy Sensitivity Level for No Motion for Extended Period

| Occupancy state transition | Time to wait for no |
|---|---|
| sensitivity level | motion detection |
| Lowest | 24 hours |
| Low | 20 hours |
| Moderate | 18 hour |
| High | 16 hours |
| Highest | 14 hours |

The following learned behaviors can be calculated and reduce the value of the time to wait parameter. A histogram of previous activity strongly suggests that the owner(s) of the designated area (e.g., home owners) are away during this time window. For example, over the past recent time-period (e.g., 30-day history, current day of the week, 60-day history, bi-weekly current day of week), the designated area has become unoccupied during this same time window (plus or minus 15 minutes from the current time). In this situation, if the value of the time to wait parameter is greater than a first minimum threshold of time (e.g., 95% of the time), then set the value of the time to wait to the highest value, or greater than a second minimum threshold of time (e.g., 80% of the time), then reduce the value of the time to wait parameter to half of the current value.

If minors are present in the designated area, set the value of the time to wait parameter to at least the value associated with the high occupancy state transition sensitivity level. If the last motion detection ended in a particular area, such as a bedroom area, and no motion was detected in the adjoining exit way, then a longer period of waiting is appropriate, in which case set the value of the time to wait parameter to the value associated with the low occupancy state transition sensitivity level.

FIG. 4 illustrates a computing environment in which an embodiment of the invention may operate. The alarm system software application 420 is a central component of the alarm system. It runs in a continual processing cycle on local controller 405 in or proximate to the designated area, receiving and using a variety of inputs as described herein with regard to FIGS. 1A-1F and 2. The application's main loop receives input from the set of sensors 410 coupled in communication with the controller 405. This may be accomplished either through a notification push from a sensor or hardware interface, or via a polling mechanism. The application receives non-sensor inputs from components within or cooperating with the alarm system, such as from user interface 430, clients 470 (e.g., laptop or desktop computers, and software applications executing thereon, that may perform some or all of the same or similar functions as user interface 430, mobile communication devices, geofencing application 435, etc.), and mobile communication devices 465, and from non-alarm system inputs, which may include: geo location data of mobile communication devices 465; geo fencing data provided by application 435; historical schedule information for known users stored in database 450 that is retrieved and stored in a local data store of memory 425; facial identification of individuals by cameras either embedded in a console, display panel, monitor, or other display device or user interface 430, or a stand-alone camera; explicitly provided user or occupant schedules; time of day; day of week; time of year; current calendar information for known system users; sun rise and sunset times; weather; etc.

It is appreciated that the alarm system software application 420, while described above as a software application wholly executing on local controller 405, could, in other embodiments, reside on and be executed by one or more application servers 460 in a cloud computing environment. In such an embodiment, functionality of the alarm system software may be distributed across one or more alarm system application server(s) 460 and local alarm system software application 420. For example, alarm system software application 420 may be little more than a web browser-based software application that gathers information and input from one or more of sensor software applications 415, user interface 430, geofencing software application 435, and mobile communication devices 465, and then accesses the alarm system application server 460 via network interface and protocols 445. The alarm system software application 420 may interact with a corresponding alarm system software application executing on system application server 460 via, for example, a web portal. In such an embodiment, the software 420 forwards such information and input to application server 460, where the alarm system software application executing on application server 460, operating in conjunction with information stored in an associated database 455, performs such steps as selecting a confidence level at 110, or selecting an action to be taken 120. Alarm system software executing on application server software 460 communicates any output to alarm system software 420 in response thereto, and the alarm system software 420, in turn, communicates with (e.g., provides output to be delivered to) one or more of the sensor software applications 415, local datastore in memory 425, user interface 430, geofencing software application 435, and mobile communication devices 465. Alternatively, some devices or applications, such as geofencing software application 435, or mobile communication devices 465, may communicate directly with alarm system software executing on application server 460. In another example, functionality of the alarm system software may be distributed across one or more alarm system application server(s) 460 and local alarm system software application 420 in such manner that the alarm system software application executing on application server 460 performs some of the steps while the local alarm system software application 420 performs other of the steps. The distribution of tasks may be configured, or context sensitive, for example, based on processing needs and/or resources. For example, in the event of a time out in communications between alarm system application servers 460 and alarm system software application 420, alarm system software application can perform tasks that software executing on the application server 460 otherwise performs.

Application 420 further pushes the received data to a main event store database 450, and, optionally, to the local history, massage data to ensure a consistent format, eliminate superfluous events, de-duplicate polled sensor data and extend an existing entry's trigger time, time stamp normalization, etc.

Application 420 further maintains a list of occupancy state objects, alarm event objects for both current alarm events as well as potential alarm events that are under being evaluated. The objects encapsulate and track the criteria for each object type, including the starting/triggering input, all subsequent sensors that contribute to the potential alarm event and any potential confidence weighting of the potential alarm event.

Application 420 manages the occupancy state and alarm event objects—triggered on a timed-basis, or upon receipt of new data to: evaluate the under-consideration transitions of confidence levels of occupancy state and potential alarm event objects based on the triggers, conditions and rules described herein, specifically the enumerated confidence levels of occupancy states and enumerated potential alarm events.

Application 420 also manages the action to be taken objects—triggered on a timed-basis or upon creation of new potential alarm event objects, including creating a new alarm event object as a result of the intersection of newly transitioned confidence level of occupancy state, potential alarm event, and alarm system sensitivity objects, processing the on-going action to be taken object based on the rules outlined in the enumerated actions to be taken discussion, including actions such as transmitting mobile communication device push notifications to appropriate users, initiating various alarm conditions as appropriate, transmitting notifications to social media as appropriate, and challenging an unknown user via a user interface console.

In this description, numerous specific details are set forth such as examples of specific systems, languages, protocols, components, etc., in order to provide a thorough understanding of the various embodiments. It should be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations as described above. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appears as set forth in the description above. In addition, embodiments are not described with reference to any particular programming language. It is appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

Although the invention has been described and illustrated in the illustrative embodiments, it is understood that this disclosure has been made only by way of example, and that numerous changes in the details of implementation of embodiments of the invention can be made without departing from the spirit and scope of the invention, which is only limited by the claims that follow. Features of the disclosed embodiments can be combined and rearranged in various ways.

What is claimed is:

1. A non-transitory computer readable storage media having instructions stored thereon that, when executed by a processor of an alarm system, cause the alarm system to perform operations comprising:
receiving input indicating occupancy state of a designated area;
selecting one of a plurality of confidence levels regarding occupancy state of the designated area responsive to the received input;
receiving notification of a potential alarm event from one or more of a plurality of sensors of the alarm system; and
selecting an action to be taken responsive to the potential alarm event and the selected one of the plurality of confidence levels.

2. The non-transitory computer readable storage media of claim 1, wherein receiving input indicating occupancy state of the designated area comprises receiving input from a user interface, and/or the plurality of sensors, of the alarm system, the input indicating occupancy state of a designated area.

3. The non-transitory computer readable storage media of claim 2, wherein receiving input from the plurality of sensors indicating occupancy state of the designated area comprises receiving input from one or more sensors selected from a group consisting of: an occupancy sensor, an alert sensor, an environmental sensor, and combinations thereof.

4. The non-transitory computer readable storage media of claim 2, wherein receiving input from the user interface comprises receiving input from zero or more authenticated individuals via one or more user interfaces of the alarm system or one or more mobile communication devices.

5. The non-transitory computer readable storage media of claim 1, wherein the designated area is selected from a group consisting of: a house, a building, a gated community, a plurality of buildings, a campus, a public or private venue, a geofenced area, and combinations thereof.

6. The non-transitory computer readable storage media of claim 1, further comprising receiving additional input from one or more mobile communication devices within or around the designated area, and wherein selecting one of the plurality of confidence levels regarding occupancy state of the designated area further comprises selecting one of the plurality of confidence levels regarding occupancy state of the designated area responsive to the received additional input.

7. The non-transitory computer readable storage media of claim 6, wherein the one or more mobile communication devices are selected from a group consisting of: a cellular communications capable mobile device, an IEEE 801.11 Wi-Fi communications capable device, a Bluetooth wireless technology communications capable device, and a global positioning satellite (GPS) communications capable device, and combinations thereof.

8. The non-transitory computer readable storage media of claim 1, further comprising receiving additional input relevant to or about the designated area, wherein the additional input is selected from a group consisting of: time of day, learned occupancy schedule, pattern of where and/or when mobile phones are present, in or absent from, the designated area, day of week, building service personnel on-site patterns, seasonal-, holiday-, or personal observances, current weather conditions, adverse and/or extreme weather conditions; and
wherein selecting one of a plurality of confidence levels regarding occupancy state of the designated area further comprises selecting one of the plurality of confidence levels regarding occupancy state of the designated area responsive to the received additional input.

9. The non-transitory computer readable storage media of claim 1, wherein the plurality of confidence levels regarding occupancy state of the designated area comprise: a lowest confidence level, a low confidence level, a high confidence level, and a highest confidence level, and continuums thereof.

10. The non-transitory computer readable storage media of claim 1, wherein receiving notification of a potential alarm event from one or more of the plurality of sensors comprises receiving notification of a potential alarm event selected from a group consisting of: typical entry door opened from inside, typical entry door opened from outside, typical entry door opened, non-typical entry door opened from inside, non-typical entry door opened from outside, non-typical entry door opened, non-used entry door opened from inside, non-used entry door opened from outside, non-used entry door opened, possible entry through closed window, possible entry through open door, window opened from inside, window opened from outside, window opened, possible entry through open window, cabinet or drawer opened, interior motion sensed, exterior motion sensed, exterior casing, glass breaking detected, flood/water detected, smoke detected, and CO2 gas detected.

11. The non-transitory computer readable storage media of claim 1, wherein selecting an action to be taken responsive to the potential alarm event and the selected one of the plurality of confidence levels comprises selecting an action from the group consisting of: no response, challenge an individual for authentication, passively notify one or more occupants, notify owner of building in, or a manager of designated area, notify adult occupant(s) of designated area, notify all occupants of designated area, send an alert to a trusted group, send an alert to a social media group, raise an alarm, sound a siren, and contact a call-center.

12. The non-transitory computer readable storage media of claim 1, further comprising receiving input regarding a sensitivity level for the alarm system, and
wherein selecting the action to be taken responsive to the potential alarm event and the selected one of the plurality of confidence levels comprises selecting the action to be taken (and the degree thereto) further responsive to the sensitivity level for the alarm system.

13. The non-transitory computer readable storage media of claim 12, wherein receiving input regarding the sensitivity level for the alarm system comprises receiving machine-learned input and/or user input regarding the sensitivity level for the alarm system.

14. The non-transitory computer readable storage media of claim 13, further comprising receiving additional input regarding the designated area or thereabouts, selected from a group consisting of: time of day, learned occupancy schedule, pattern of where and/or when mobile phones are present, in or absent from, the designated area, day of week, building service personnel on-site patterns, seasonal-, holiday-, or personal observances, current weather conditions, adverse and/or extreme weather conditions; and
wherein selecting the action to be taken responsive to the potential alarm event, the selected one of the plurality of confidence levels, and the sensitivity level for the alarm system comprises selecting the action to be taken further responsive to the received additional input.

15. The non-transitory computer readable storage media of claim 1, further comprising receiving input selecting an occupancy state transition sensitivity level, and
wherein selecting one of a plurality of confidence levels regarding occupancy state of the designated area responsive to the received input further comprises selecting one of the plurality of confidence levels regarding occupancy state of the designated area further responsive to the selected occupancy state transition sensitivity level.

16. The non-transitory computer readable storage media of claim 15, the occupancy state transition sensitivity level is selected from a group consisting of: lowest sensitivity, low sensitivity, moderate sensitivity, high sensitivity, and highest sensitivity.

17. The non-transitory computer readable storage media of claim 15, wherein selecting the one of a plurality of confidence levels regarding occupancy state of the designated area further responsive to the selected occupancy state transition sensitivity level comprises selecting the one of a plurality of confidence levels according to an associated schedule for transitioning to the selected one of the plurality of confidence levels regarding occupancy state of the designated area.

18. The non-transitory computer readable storage media of claim 17, further comprising:
receiving input regarding learned behaviors of individuals that have occupied the designated area;
adjusting the associated schedule for transitioning to the selected one of the plurality of confidence levels regarding occupancy state of the designated area responsive to the received input regarding individuals that have occupied the designated area; and
wherein selecting the one of a plurality of confidence levels according to the associated schedule for transitioning to the selected one of the plurality of confidence levels regarding occupancy state of the designated area comprises selecting the one of a plurality of confidence levels according to the adjusted associated schedule for transitioning to the selected one of the plurality of confidence levels regarding occupancy state of the designated area.

19. A method for selecting an action to be taken by an alarm system for a designated area, the method comprising:
receiving an input indicating occupancy state of the designated area;
selecting one of a plurality of confidence levels regarding occupancy state of the designated area responsive to the received input;
receiving notification of a potential alarm event from one or more of a plurality of sensors within or proximate to the designated area; and
selecting an action to be taken responsive to the potential alarm event and the selected one of the plurality of confidence levels.

20. The method of claim 19, wherein receiving the input indicating occupancy state of the designated area comprises receiving input from a user interface, and/or the plurality of sensors, the input indicating occupancy state of a designated area.

21. The method of claim 20, wherein receiving input from the plurality of sensors indicating occupancy state of the designated area comprises receiving input from one or more sensors selected from a group consisting of: an occupancy sensor, an alert sensor, an environmental sensor, and combinations thereof.

22. The method of claim 19, further comprising receiving additional input from one or more mobile communication devices within or around the designated area, and wherein selecting one of the plurality of confidence levels regarding occupancy state of the designated area further comprises selecting one of the plurality of confidence levels regarding occupancy state of the designated area responsive to the received additional input.

23. The method of claim 19, further comprising receiving additional input relevant to or about the designated area, wherein the additional input is selected from a group consisting of: time of day, learned occupancy schedule, pattern of where and/or when mobile phones are present, in or absent from, the designated area, day of week, building service personnel on-site patterns, seasonal-, holiday-, or personal observances, current weather conditions, adverse and/or extreme weather conditions; and
wherein selecting one of a plurality of confidence levels regarding occupancy state of the designated area further comprises selecting one of the plurality of confidence levels regarding occupancy state of the designated area responsive to the received additional input.

24. The method of claim 19, wherein the plurality of confidence levels regarding occupancy state of the designated area comprise: a lowest confidence level, a low confidence level, a high confidence level, and a highest confidence level, and continuums thereof.

25. The method of claim 19, further comprising receiving input regarding a sensitivity level for the alarm system, and
wherein selecting the action to be taken responsive to the potential alarm event and the selected one of the plurality of confidence levels comprises selecting the action to be taken further responsive to the sensitivity level for the alarm system.

26. The method of claim 19, further comprising receiving input selecting an occupancy state transition sensitivity level, and
wherein selecting one of a plurality of confidence levels regarding occupancy state of the designated area responsive to the received input further comprises selecting one of the plurality of confidence levels regarding occupancy state of the designated area further responsive to the selected occupancy state transition sensitivity level.

27. An alarm system that selects an action to be taken for a designated area, the alarm system comprising:
a computer interface to receive input indicating occupancy state of the designated area;
logic to select one of a plurality of confidence levels regarding occupancy state of the designated area responsive to the received input;
logic to receive notification of a potential alarm event from one or more of a plurality of sensors within or proximate to the designated area and coupled in communication with the alarm system; and
logic to select an action to be taken responsive to the potential alarm event and the selected one of the plurality of confidence levels.

28. The apparatus of claim 27, further comprising logic to receive additional input from one or more mobile communication devices within or around the designated area, and wherein the logic to select one of the plurality of confidence levels regarding occupancy state of the designated area further comprises logic to select one of the plurality of confidence levels regarding occupancy state of the designated area responsive to the received additional input.

29. The alarm system of claim 27, further comprising logic to receive input regarding a sensitivity level for the alarm system, and
wherein the logic to select the action to be taken responsive to the potential alarm event and the selected one of the plurality of confidence levels comprises logic to select the action to be taken further responsive to the sensitivity level for the alarm system.

30. The apparatus of claim 27, further comprising logic to receive input to select an occupancy state transition sensitivity level, and
wherein the logic to select one of a plurality of confidence levels regarding occupancy state of the designated area responsive to the received input further comprises logic to select one of the plurality of confidence levels regarding occupancy state of the designated area further responsive to the selected occupancy state transition sensitivity level.
